(19) United States
(12) Patent Application Publication
(10) Pub. No.: US 2012/0096077 A1
(43) Pub. Date: Apr. 19, 2012

(54) SYSTEM FOR MAKING AN APPLICATION AVAILABLE ON A USER TERMINAL

(75) Inventors: Gérard Weerts, Howald (LU); Cédric Rouard, Vieux-Waleffe (BE)

(73) Assignees: GERARD WEERTS, HOWARD (LU); COLETTE DERIDDER, VIEUX-WALEFFE (BE); CEDRIC ROUARD, VIEUX-WALEFFE (BE)

(21) Appl. No.: 13/264,558

(22) PCT Filed: Apr. 16, 2010
(86) PCT No.: PCT/EP10/55052

§ 371 Date: Nov. 29, 2011

(30) Foreign Application Priority Data
Apr. 17, 2009 (FR) 0952539

(51) Int. Cl. G06F 15/16

(52) U.S. Cl. 709/203

(57) ABSTRACT

A system for making an application available on a user terminal, includes a user terminal that is connectable to an interface for selecting the application from among a plurality of virtual applications, at least one first physical server divided into a plurality of virtual machines, a storage device for storing a plurality of virtual applications, wherein selecting the application causes the corresponding virtual application to be loaded and run on an unused virtual machine from among the plurality of virtual machines of the first physical server, each virtual machine being capable of loading and running a single application, a second warehousing physical server, a first transfer channel for transferring the display of the application run by the virtual machine to the second server and a second transfer channel for transferring the display of the second server to the user terminal.

The invention relates to a system for making an application available on a user terminal.

It is known that some corporate computing infrastructures use virtual applications. This technology consists in encapsulating the application and its system environment in the same package, in the form of an executable. In addition, a virtual application does not require a specific installation. A user can open the virtual application simply by clicking on an icon. The application is then downloaded to a physical machine from a local network, typically the internet, or from a mobile, support. An application is executed locally, that is to say on the physical machine. It should be noted that a virtual application is designed to work on only one operating system.

However, this type of solution is associated with a number of drawbacks. A first drawback consists in that a trace on the user terminal (that is to say typically a local file) is generated by the download and by the execution of the virtual application.

A second drawback consists in that the virtual application is executed on the user's machine. In other words, a virtual application that contains or downloads a virus is capable of infecting the user when it executes.

A third drawback consists in that the virtual application is designed for only one operating system. More often than not, the virtual application is incompatible with different operating systems.

According to a known improvement to these virtual applications intended to alleviate the above drawbacks, “streaming” of applications also consists of a virtualisation of applications in which the virtual application only loads the elements it needs to function.

As a result, “streaming” of applications is associated with drawbacks very similar to those described above. Moreover, many companies use remote office access technologies of the Terminal Server type to manage their IT inventories. According to an implementation of this kind, a number of applications are installed on a single server. The users who have authorisation to access the server may then access the various applications from their respective machines. However, such a technology is also associated with drawbacks to the extent that the applications are executed in a common environment formed by the server. Consequently, the various applications are able to interact among themselves within the common environment.

Thus, two different versions of the same software are sometimes incompatible and can be in conflict with one another. To alleviate this drawback only one software version is generally installed on the server.

It addition, it sometimes happens that a version of a first software product is not compatible with the version of a second software product. As a consequence, the first and second software products cannot function in a shared environment. Added to this, certain applications are not designed to function on a server and must be configured accordingly. The costs associated with obtaining licences for software designed to run on a server are affected by this.

An additional drawback consists in the fact that the server is vulnerable to being infected by a computer virus as soon as a user connects to the internet. De facto, when the server is infected with a computer virus, all users on that server are at risk of being infected by the virus.

Moreover, this type of system requires the installation of a heavy local client to enable users to obtain authorisation to access the server. Accordingly the performance of the user terminal is impaired. Furthermore a trace of this client still remains on the user terminal.

It is also known to virtualise a complete work environment. In such a situation applications are executed on virtual machines. This feature makes it possible to render the question of compatibility between the applications and the operating system on the user system irrelevant.

By way of example, patent application number WO 2009/001221 describes a system that enables virtualisation of complete work environment. More precisely, the document discloses a system that consists of creating a secure user account. This user account enables the user access via the internet to a virtual IT environment that offers plurality of virtual applications. This IT environment is created on a remote physical server. The user may thus access this IT environment remotely. The system then offers the user the possibility of running applications remotely. Consequently, when the user disconnects, the virtual IT environment that be integrated in a virtual office continues to exist. Furthermore, the user may access this virtual office from another computer, since access is granted to him via his user account.

Such a system presents drawbacks, however, since the applications function in a shared environment. In other words, they can interact. The main drawbacks are essentially similar to those described in the preceding, that is to say:
Risk of incompatibility of different software versions, and

Risk of incompatibility of some software among themselves.

Against this context, the object of the invention is to eliminate the problems described in the preceding by suggesting a system that allows the use of different software programs and/or software versions without any compatibility restrictions and without any risk of contamination by a virus when it is used by different users, and the execution of the software does not affect the performance of the user terminal in any way.

To this end, the invention is directed to a system for making available an application on a user terminal, said system comprising:
a user terminal capable of being connected to an interface for selecting the said application from a plurality of virtual applications;
at least one first physical server partitioned into a plurality of virtual machines;
means for storing a plurality of virtual applications, selection of said application causing the loading and execution of the corresponding virtual application on an unused virtual machine from among the said plurality of virtual machines of said at least one first physical server, each virtual machine being designed to load and execute only a single application;
a second physical server for warehousing;
means for transferring the display from said application executed on the virtual machine to said second server; and
means for transferring the display from said second server to said user terminal.
In addition to the main features, which have been described briefly in the previous paragraph, the system according to the invention may include one or more additional features, as described in the following, considered individually or in any technically possible combination:
   said first and second physical servers are connected via a local network, said user terminal being capable of communicating with said local network via a first remote network access protocol;
   said user terminal comprises a java virtual machine and a java applet running on said java virtual machine and enabling said first remote network access protocol to be interpreted;
   said selection interface is a secure web interface;
   the operating system of said virtual machines is stripped down so that it only contains the elements essential for running the said virtual applications;
   the system according to the invention includes activation means capable of selecting a virtual machine an of causing a virtual machine to switch from a first, standby state to a second, active state;
   a virtual machine transfers to said second server only the display of the one or more windows of said application that is executing on said virtual machine;
   each of said virtual applications encapsulates an application and its corresponding system environment;
   said storage means of said virtual applications are formed by a network share disk.

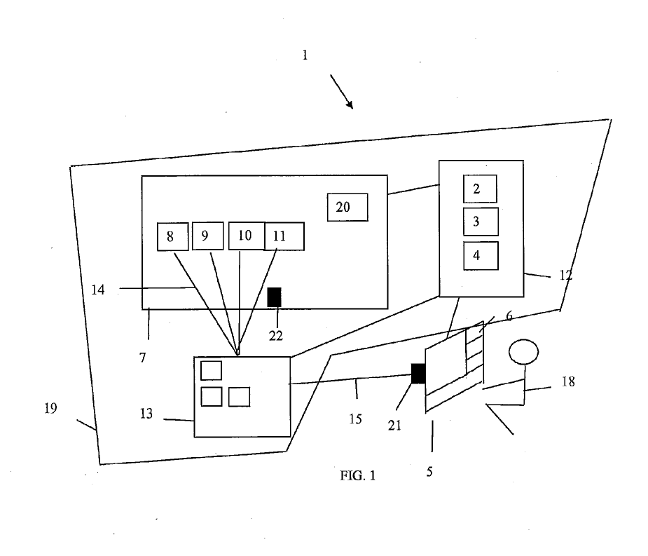

Other features and advantages of the invention will be clearly evident from the description provided below, solely for illustrative purposes and in no way intended to be limiting, of variants thereof, by reference to the attached FIG. 1, in which the elements of the system according to the invention are represented. For the sake of clarity, only elements that are pertinent to the understanding of the invention are represented, and are not drawn to scale or in accordance with any diagrammatic convention.

A system 1 enabling a user 18 to access a plurality of remote virtual applications 2, 3, 4 according to the invention is shown in FIG. 1. More particularly, the FIGURE represents:
a user terminal 5;
a user 18;
a first physical server 7;
four virtual machines 8, 9, 10, 11;
actuation means 20;
a second warehousing server 13 for displays;
three virtual applications 2, 3, 4;
storage means 12 for the three virtual applications 2, 3, 4;
a selection interface 6 for the three virtual applications 2, 3, 4 that are able to be formed by a secure web interface;
means 15 for transferring the display of second server 13 to user terminal 5. For example, a web server is located on second server 13 and its display is transferred to user terminal 5;
means 14 for transferring the display of virtual machines 8, 9, 10, 11 to second server 13;

Virtualisation applications enable first physical server 7 to be partitioned. These virtualisation applications may be installed on any kind of physical server and partition the physical server into several virtual machines 8, 9, 10, 11. For the purposes of the following description, the term virtual machine is understood to mean a server that does not contain any electronic equipment and which has been optimised to load and execute applications and/or programs. When a virtual machine is not requested, it remains in a state of minimum execution. This state of minimum execution consists of reducing the resources used at the processor and memory level to a maximum. In other words, it is in a standby state. Then, as soon as it is requested the resources are increased to elevate its performance. This request is effected by activation means 20.

In addition a virtual application is obtained by the application virtualisation, which consists in encapsulating the application and its system environment in the same package which is inaccessible at the destination system.

It should also be noted that for the purposes of the following description virtual machines 8, 9, 10, 11 are machines on which the operating system has been stripped down, that is to say all elements that are not essential for the execution of the virtual applications have been deleted to enable them to execute as fast as possible. In addition, virtual machines 8, 9, 10, 11 are each equipped with their own operating system. Thus, when a virtual application 2, 3, 4 is loaded and run on a virtual machine 8, 9, 10, 11, it runs autonomously and does not require any external elements.

For the purposes of non-limiting explanation, second physical server 13 serves to warehouse and display multiple displays originating from the four virtual machines 8, 9, 10, 11.

In one possible embodiment of the invention of a system 1 consistent with the invention illustrated in FIG. 1, user 18 is able to access the display of second server 13 via user terminal 5. This user terminal 5 may be constituted for example by a computer workstation, a personal computer, indeed even a mobile phone or any other type of device that is capable of accessing the internet.

When second server 13 is accessed for the first time, user 18 must create a user account via secure web interface 6. Subsequently, this user account thus enables user 18 to access second server 13 in an private and secure manner. This access is available to the user regardless of which user terminal 5 is used, provided it has access to the internet. The creation of this account enables the user to obtain a password, for example.

When user 18 connects, he is able to access second server 13 via secure web interface 6. User 18 must provide the password obtained beforehand. Second server 13 offers user 18 a choice of several virtual applications 2, 3, 4. However, this does not mean that these virtual applications 2, 3, 4 are accessible to him. Some may required a payment and access may be dependent on a subscription. This access may be, in non-limiting manner, either for a predetermined period, for example for a year, a month; or for a limited number of uses, such as for example 100 or 25 uses, or indeed 30 or 120 minutes.

In our example, user 18 subscribes to the three chargeable virtual applications 2, 3, 4 for a period of two months. These virtual applications 2, 3, 4 may be, for example and in non-limiting manner, word processing or spreadsheet or text editing applications.

The three virtual applications 2, 3, 4 to which user 18 has subscribed are then accessible to him via second server 13. As soon as user 18 identifies himself on secure web interface 6 with his password, first remote network access protocol 21 between user terminal 5 and second server 13 ensures rapid, fluid communication between these two elements. For example, the user terminal may use a first access protocol of type NX™. This particularly enables irrelevant elements not to be transmitted and elements to be placed in the cache memory to reduce latency and access time.

Second server 13 then offers user 18 the choice of accessing the three virtual applications 2, 3, 4 to which he has subscribed.

When user 18 selects one of the three virtual applications 2, 3, 4, activation means 20 select a virtual machine that is capable of executing the selected application. It should be noted that the virtual machines cited above are capable of loading and executer only one application. In other words, tow virtual applications 2 and 3 cannot be executed simultaneously on the same virtual machine 8.

For illustrative, non-limiting purposes, user 18 selects a first virtual application 2 of a type for word processing. The version of this word processing is, for example, version V1.

Then, user 18 selects a second virtual application 3, which is similar, that is to say a word processing type. However, it should be noted that version V2 of this second virtual application 3 is a newer version than version V1.
first virtual application 2 is loaded and executed for example on a first virtual machine 8 which is in a minimal execution state; and
second virtual application 3 is for example loaded and executed on a second virtual machine 9 which is in a minimal execution state.

As soon as virtual applications 2 and 3 are loaded, resources at the processor and memory level are allocated by activation means 20 to the two virtual machines 8 and 9 so that their processing speed is increased.

The displays of first virtual application 2 and second virtual application 3 are transferred to second server 13. In other words, second server 13 serves as a display warehouse. In order to optimise user comfort and the display space available on the user terminal, only the displays of the application windows are transferred to second server 13. This feature is achieved with a second remote office access protocol 22 (typically RDP). In this example, we explained, that the windows of two virtual applications 2 and 3 may be displayed on server 13 but it is understood that the number of displays may be more or less. Besides, it should be noted that second server 13 serves to warehouse the display of virtual applications being run by one or more users.

Each of the two virtual applications 2 and 3 runs in isolated manner that is to say on a different virtual machine. As a result it is impossible for virtual applications 2 and 3 to interact.

This configuration advantageously offers the possibility of using one user terminal 15 for multiple applications, which under normal circumstances are not intended to coexist. For informational purposes, the virtual machines 8, 9, 10, 11 created are cleared to as far as possible of all elements that are not essential for the use of the intended applications 2, 3, 4. For example, not all screen backgrounds are loaded.

It should also be, noted that the operations carried out by user 18 are transmitted simultaneously to second server 13 and to the virtual machine 8, 9, 10, 11 corresponding to the application that user 18 is using. The term operation is understood to mean the act of typing on a keyboard or Moving a mouse on user terminal 5.

As soon as user 18 no longer calls virtual applications 2 and 3, the respective applications are unloaded from virtual machines 8 and 9, that is to say virtual applications 2 and 3 in our example. Virtual machines 8 and 9 return to their initial state and do not contain any contamination in the nature of an undesirable user file or any other element that would hinder proceedings the next time either of virtual applications 2 or 3 is launched.

When virtual applications 2, 3, 4 are used, the data may be recorded on physical server 7 and/or on user terminal 5. It should be noted that advantageously none of the virtual applications 2, 3, 4 is recorded and/or executed on user terminal 5.

In general, system 1 consists on the one hand of one or more first physical servers 7, partitioned into a plurality of virtual machines 8, 9, 10, 11, each of which is equipped with its own minimal operating system, that is to say reduced to the bare minimum, and on the other hand means 12 for storing virtual applications 2, 3, 4. Virtual applications 2, 3, 4 are packaged. This feature means that it is not necessary to install virtual applications 2, 3, 4 on virtual machines 8, 9, 10, 11 and virtual applications 2, 3, 4 do not have to be installed and/or run on user terminal 5.

In general virtual applications 2, 3, 4 are formed by a package that contains the application and its DLL type dependencies. The package is pre-created in the form of an executable.

The package is placed on first physical server 7 and when user 18 wishes to launch a virtual application 2, 3 or 4, it is imported onto a virtual machine 8, 9 10 or 11 via activation means 20 and executes automatically there. The display is transmitted from said virtual machine 8, 9 10, 11 to second server 13 via means 14 and then from second server 13 to user terminal 5 via means 15. Advantageously, this mechanism enables the disk space to be optimised. Thus, physical server 7 is as light as possible because it does not contain any elements that are not essential for executing virtual applications 2, 3, 4.

User 18 is advantageously able to connect to second server via any type of user terminal 5 that provides the capability to connect to secure interface 6. To do this, it is advantageous if user terminal 5 includes a java virtual machine and a java applet. The applet may be loaded directly onto user terminal 5 when connecting to second server 13.

According to an embodiment within the scope of the invention but not illustrated, a virtual application 2 is called by three users 18. This virtual application 2 is loaded and executed on three different virtual machines 8, 9, 10. As a result, the executions of the same virtual application 2 are isolated and the virtual application 2 that is executed on virtual machine 8 cannot interact with the virtual application that is running on virtual machine 9.

It will also be noted that the system according to the invention may include a plurality of first physical servers. All of the physical servers (that is to say those that host the virtual machines and the warehousing server) are preferably hosted in a data centre which means that the high pass bandwidth necessary to improve smooth access to the servers can be made available, quite apart from the physical and electrical security and protection in the event of fire; in other words, there is no need to depend on the end user's ability to access the internet at the site of use.

In summary, the invention particularly enables:
execution of a plurality of applications that are not compatibles;
isolation of the applications on a user terminal without having to transfer the problem to a remote machine;
authorised access to a local network 19 from any user terminal 5 that has access to the Internet; this access is carried out via first remote network access protocol 21;
elimination of the effects on the latency of internet accesses;
elimination of all traces on the user terminal;

The invention is described in the preceding purely for exemplary purposes. It is understood that one skilled in the art would be able to create different variants of the process and/or of the system according to the invention Without exceeding the scope of the patent.

1. A system for making an application available on a user terminal, said system comprising:
a user terminal capable of connecting to an interface for selecting said application from a plurality of virtual applications;
at least one first physical server partitioned into a plurality of virtual machines;
a storage device for storing a plurality of virtual applications, selection of said application causing the loading and execution of the corresponding virtual application on an unused virtual machine from among the said plurality of virtual machines of said at least one first physical server (, each virtual machine being designed to load and execute only a single application;
a second physical server for warehousing;
a first transfer channel for transferring the display from said application executed on the virtual machine to said second server; and
means a second transfer channel for transferring the display from said second server to said user terminal.

2. The system as recited in claim 1, wherein said first and second physical servers are connected via a local network, said user terminal being capable of communicating with said local network via a first remote network access protocol.

3. The system as recited in claim 2, wherein said user terminal comprises a java virtual machine and a java applet running on said java virtual machine and enabling said remote network access protocol to be interpreted.

4. The system as recited in claim 1, wherein said selection interface is a secure web interface.

5. The system as recited in claim 1, wherein the operating system of the said virtual machines is stripped down so that it the operating system only contains the elements essential for running the said virtual applications.

6. The system as recited in claim 1, comprising an activation module capable of selecting a virtual machine and of causing the virtual machine to switch from a first, standby state, to a second, operating state.

7. The system as recited in claim 1 any of the previous claims, wherein a virtual machine transfers to said second server only the display of the one or more windows of the said application that is currently executing on said virtual machine.

8. The system as recited in claim 1, wherein each of the said virtual applications encapsulates an application and a corresponding system environment thereof.

9. The system as recited in claim 1 wherein said storage device for said virtual applications are formed by a network share disk.
